(19) United States
(12) Patent Application Publication
(10) Pub. No.: US 2005/0008759 A1
(43) Pub. Date: Jan. 13, 2005

(54) Grain protein-based formulations and methods of using same

(76) Inventors: Li Nie, Kansas City, MO (US); Clodualdo Maningat, Platte City, MO (US); Sukh Dev Bassi, Atchison, KS (US)

Correspondence Address: LATHROP & GAGE LC, 4845 PEARL EAST CIRCLE, SUITE 300, BOULDER, CO, 80301, US

(21) Appl. No.: 10/617,565

(22) Filed: Jul. 11, 2003

(51) Int. Cl. A23J 1/00

(52) U.S. Cl. 426/656

(57) ABSTRACT

Shelf stabilizing agents including hydrolyzed protein, hydrolyzed protein derivatives, and hydrolyzed protein-emulsifier complexes improve the shelf life of a pelletized grain protein-based resin formulation. The pellets may be prepared well in advance of further processing, such as by injection molding and extrusion, which provides shaped articles of the edible or biodegradable variety.

### FIELD OF THE INVENTION

The present invention broadly concerns a grain protein formulation having an improved shelf life. More particularly, protein resin formulations may be manufactured in pelletized form well in advance of final production processing that converts the pellets into shaped articles of manufacture, for example, by injection molding, extrusion or other forming equipment. Shelf life of the protein resin formulations is enhanced by the addition of shelf stabilizing agents, such as hydrolyzed proteins, hydrolyzed protein derivatives, and hydrolyzed protein/hydrolyzed protein derivative-emulsifier complexes. The articles of manufacture from such resins may be pet chew treats, edible products, and biodegradable articles.

### BACKGROUND OF THE INVENTION

Petroleum-based synthetic resins have achieved widespread use in the fabrication of a multitude of products. Grain-based resins have also been used. For example, U.S. Pat. No. 5,665,152 issued to Bassi et al., which is incorporated by reference herein, describes formulations and processing methods for grain-based protein products. Grain proteins may be prepared as resin pellets, which can then be used for many applications, including extrusion and injection molding applications. However, if the resin pellets are not used in these processes within a short time of resin production, e.g., a few weeks, the molded articles begin to show signs of rough and bumpy surfaces due to aging of the resin pellets. The strength of the injection molded articles can also decrease. These problems increase with time after resin production, which necessitates the use of the resin pellets shortly after production.

Thus, it would be a valuable contribution to the art to provide grain protein-based resin formulations having improved aging properties for use in shaped, molded, and extruded objects.

### SUMMARY OF THE INVENTION

In one aspect, the resin aging problem is addressed by incorporating a certain amount of a shelf-stabilizing agent, such as hydrolyzed proteins, hydrolyzed protein derivatives, hydrolyzed protein/hydrolyzed protein derivative—emulsifier complexes, and mixtures thereof in the formulation for the resin pellets made by extrusion processes.

Formulation details for the making of resin pellet are also provided.

Methods of preparing the grain protein-based resin pellets and molding methods, such as injection molding, are yet further provided.

### BRIEF DESCRIPTION OF THE DRAWINGS

FIG. 1 illustrates a comparison of injection molded pet chew products made from aged and non-aged wheat gluten based resin pellets.

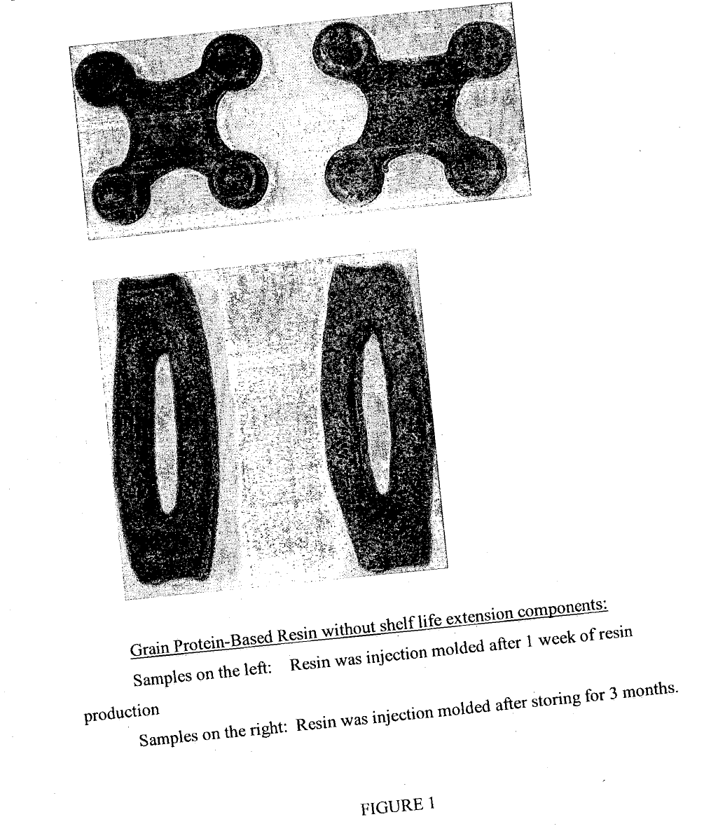

### DETAILED DESCRIPTION OF THE INVENTION

The term “%” as employed throughout the specification and claims refers to weight percent unless otherwise specifically noted in the text.

Broadly speaking, one method of the invention first comprises the step of providing a formulation especially designed to have melt flow and rheological propertiers allowing the formulation to be processed using conventional plastics forming equipment. This formulation is then heated under moderate temperature conditions, usually with shear, to create a substantially homogeneous and flowable formulation. The most common way of making the resin pellets is by extrusion processes. Both single and twin-screw extruders can be used, with more preference being given to twin-screw extrusion due to better mixing and pumping action. The resin pellets can then be formed into desired articles using injection molding, extrusion or other forming equipment. Very importantly, the resin formulation may be prepared for later use as a substantially homogeneous and flowable product with the avoidance of any substantial heat denaturation of the grain protein. During the formation of the final desired articles, the substantially undenatured protein is denatured. Thus, in the context of injection molding, the preferred temperature conditions of molding are selected to assure essentially complete protein denaturation. It is also the case that certain water soluble denatured proteins, such as soy proteins, may be used in the resins, in which case the resin may be further denatured or cured by the injection molding, extrusion or other forming equipment.

The resin aging problem is associated with chemical and/or conformational change in the resin pellets. It has been discovered that shelf life of the resin formulations may be significantly extended by formulating an undenatured grain-based protein with a certain amount of shelf stabilizing agent, such as hydrolyzed proteins, hydrolyzed protein derivatives, hydrolyzed protein/hydrolyzed protein derivative—emulsifier complexes, and mixtures thereof.

Heat denaturation of protein means the protein in its hydrated and plasticized state undergoes heat treatment that results in the protein losing its visco-elasticity or viscous flow (melt flow) property. The melt flow viscosity increases as the degree of heat denaturation increases. There is little or no melt flow property if the protein is completely heat denatured. For example, corn gluten meal coming out of the dryer of a wet milling process is severely heat denatured and, therefore, is not useful in the pellet resin formulation to provide useful rheological properties for purposes of the present invention. On the other hand, commercially available vital wheat gluten is processed to provide minimum heat denaturation and, in combination with the shelf-stabilizing agents, is a suitable grain protein source for the present invention. Commercially available soy protein products may possess varying degrees of heat denaturation resulting from their preparation; however, most possess good melt flow properties with adequate plasticization due to the water solubility of soy protein.

In more detail, the preferred grain protein-based formulation includes from about 20% to about 80% by weight grain protein, and preferably from 30% to 75%. Although a variety of grain proteins can be employed, most preferably the protein is selected from the group consisting of soy protein, wheat gluten, corn gluten and mixtures thereof. In preferred forms, the grain protein has substantially no heat denaturation and as used is naturally occurring. Normally, for reasons of economy and ease of formulation, the grain protein is provided as a part of a mixture which would typically include other optional ingredients such as starch, lipids, bran and combinations thereof. For example, soy meals, concentrates and isolates could be used, as well as various commercial grades of wheat and corn gluten. When such mixtures are used, typically they would provide at least about 50% by weight of the desired grain protein, and more preferably at least about 75% by weight thereof.

The most important aspect of the present invention is to address the resin pellet aging problem by incorporating in the formulation a shelf-stabilizing agent, such as hydrolyzed proteins, hydrolyzed protein derivatives, hydrolyzed protein/hydrolyzed protein derivative—emulsifier complexes, or mixtures thereof.

The hydrolyzed proteins to be employed in the invention may, for example, include hydrolyzed wheat gluten, hydrolyzed soy protein, hydrolyzed corn gluten, hydrolyzed potato protein, hydrolyzed rice protein, hydrolyzed gelatin protein, hydrolyzed collagen, hydrolyzed casein, hydrolyzed whey protein, hydrolyzed milk protein, hydrolyzed egg white, hydrolyzed egg yoke, hydrolyzed whole egg, hydrolyzed chicken liver, hydrolyzed pork liver, hydrolyzed beef liver, hydrolyzed fish liver, hydrolyzed meat protein of any source, hydrolyzed fish, hydrolyzed blood plasma, and mixtures thereof. Preferred protein hydrolysates are hydrolyzed wheat gluten, hydrolyzed soy protein, hydrolyzed liver proteins. The hydrolyzed protein is generally present in the range of from about 0.5% to about 25% by weight of the formulation. Preferred for the practice of the invention is a hydrolyzed protein of from about 1.5 to about 20% by weight. Particularly preferred for the practice of the invention is a hydrolyzed protein amount of from about 2% to about 15% by weight.

To best use the hydrolyzed proteins to address the aging problem of resin pellets, it is preferable to have the number average molecular weight and weight average molecular weight of the hydrolyzed protein component in the practice of the present invention, less than 10,000 and 20,000 Daltons, respectively.

Hydrolyzed proteins may be prepared by any means. Typically, enzymatic hydrolysis or acid hydrolysis is employed. Preferred for the practice of the present invention is enzymatic hydrolysis. The hydrolysate is typically adjusted to a pH of 4-7.5 using NaOH, KOH, Ca(OH)₂, and the like, before spray or flash drying the product.

Examples of hydrolyzed protein derivatives include reaction products of protein hydrolysates with other chemicals or low molecular weight polymer or oligomer ingredients. The reaction products contain a hydrolyzed protein moiety and a derivative portion. The amount of hydrolyzed protein in the derivative reaction products may range from about 0.5% to about 50% depending on the reaction chemicals used. Examples are reaction products of hydrolyzed protein with anhydride, ethylene oxide, propylene oxide, fatty acid derivatives, reducing sugars, maltodextrin, oligosaccharides, dextrin, and the like.

The amount of hydrolyzed protein derivatives to be employed in the formulation may be from about 1% to about 25%. Preferred for the practice of the invention is a hydrolyzed protein derivatives of from about 1.5 to about 20%. Particularly preferred for the practice of the invention is a hydrolyzed protein derivative amount of from about 2 to about 15%.

The hydrolyzed protein/hydrolyzed protein derivatives-emulsifier complex of the present invention may be prepared from hydrolyzed protein moieties and hydrolyzed protein derivative moieties bonded physically with emulsifiers. Suitable emulsifiers to be used in the present invention include hydrolyzed vegetable oil, hydrolyzed animal fat, hydrolyzed lecithin and their salt forms, hydrolyzed lecithin modified further by ethylene oxide and propylene oxide, ethoxylated mono- and diglycerides, diacetyl tartaric acid ester of mono-diglycerides, sugar esters of mono- and diglycerides, propylene glycol mono- and diesters of fatty acids, calcium stearoyl-2-lactylate, lactylic stearate, sodium stearoyl fumarate, succinylated monoglyceride, sodium stearoyl-2-lactylate, polysorbate 60, or any other emulsifier that contains both hydrophobic and hydrophilic portions in the structure, and mixtures thereof. The amount of emulsifiers in the complex is from about 10-30% by weight of the complex.

The amount of hydrolyzed protein/hydrolyzed protein derivatives-emulsifier complex to be employed in the formulation for resin production may be from about 1 to about 25%. Preferred for the practice of the invention is a hydrolyzed protein/hydrolyzed protein derivatives-emulsifier complex of from about 1.5 to about 20%. Particularly preferred for the practice of the invention is a hydrolyzed protein/hydrolyzed protein derivatives-emulsifier complex amount of from about 2 to about 15%.

The formulation of resin pellets may also contain from about 10-40% plasticizers in the starting formulations, and more preferably from about 10-35% by weight. The preferred class of plasticizers include those selected from the group consisting of, glycerol, diglycerol, propylene glycol, triethylene glycol, urea, sorbitol, mannitol, maltitol, hydrogenated corn syrup, polyvinyl alcohol, polyethylene glycol, and mixtures thereof. The most preferred plasticizer is glycerol.

The extrudable formulations of the invention may also include a minor amount of water, up to 14% by weight, more preferably up to about 12% by weight, and most preferably from about 2-10% by weight. The presence of excess water leads to a sticky, stretchy extrudate unsuited for use in the formation of solid non-edible products. The moisture content in the resin pellets is preferably controlled from about 5-12%.

The formulation of resin pellets may also contain from about 0.5% to 5% lubricants. The presence of lubricants helps extrusion process and molding operation for ease of melt flow and melt temperature control. The lubricants may include glycerol mono/di-stearate, hydrolyzed lecithin and derivatives, fatty acid and derivatives. The preferred lubricant is glycerol monostearate.

The formulation of resin pellets may also contain from about 0.5% to 3% mold release agents. The presence of such releasing agent prevents the parts or articles from sticking to the molding surface or processing surface in general. The mold release agents may be magnesium stearate, calcium stearate, barium stearate, or other alkaline earth metal fatty acid agents. A particularly preferred mold release agent is magnesium stearate.

The formulation of resin pellets may also contain from about 0.5% to 5% reducing agent. The reducing agent cleaves the disulfide bonds in the grain protein. This drastically improves the flow and mixing of the grain protein in the processing equipment, rendering the overall formulation more suitable for use therein. The reducing agent is preferably present in a minor amount of at least about 0.01% by weight, and more preferably from about 0.05-3% by weight, where these weights are based upon the total amount of grain protein being taken as 100% by weight. The reducing agents are advantageously selected from the group consisting of the alkali metal and ammonium sulfites, bisulfites, metabisulfites and nitrites, and mercaptoethanol, cysteine, cysteamine, sulfur dioxide, ascorbic acid and mixtures thereof. A particularly preferred reducing agent is sodium metabisulfite.

Normally, the reducing agent is simply added to the other components of the formulation prior to or as a part of the extrusion process. Alternately, the reducing agent can be used to preliminarily treat the selected grain protein(s) prior to preparation of the starting formulation. Thus, in the case of gluten products (wheat and corn gluten), the reducing agent may be initially added to obtain a modified gluten product which then is employed as a part of the extrusion formulation. In any case, the reducing agent is preferably used in an effective amount to cleave from about 5-100% of the disulfide bonds in the grain protein.

A number of other ingredients can also be used in the starting extrusion formulations. Those optional ingredients may include: (1) fillers such as native or chemically modified starches in their granular form (wheat starch, corn starch, potato, rice, tapioca starches, and mixtures thereof, chemical modifications being oxidation, acetylation, carboxymethylation, hydroxyethylation, hydroxypropylation, and alkylation), calcium carbonate, heat denatured animal or vegetable protein granules or powder, vegetable powder, granules or special shape-cuts, rice flour, wheat flour, corn gluten meal, fibers (cellulose fiber, micro-crystalline fiber, soluble fibers, wheat bran, soy bean fiber, corn grit fiber); (2) pigments (titanium dioxide, carbon black, talc, calcium carbonate); (3) coloring agents (azo dyes, chlorophyll, xanthophyll, carotene, indigo, all the synthetic colors, natural coloring agents); (4) foaming agents (sodium bicarbonate, N₂ and CO₂), and (5) other special effect ingredients such as breathe and dental cleaning ingredients. These optional ingredients may, for example, provide from about 0.001% to 75% by weight of the resin pellets.

The formulations of the invention can be formed into pellets which can later be used in molding equipment or shaped by various methods, as illustrated in U.S. Pat. No. 5,665,152. For example, such pellets may be formed by extrusion, using either single or twin screw extruders. However, it is important to maintain the temperature of the material within the extruder barrel below about 95° C. to avoid heat denaturation of the matrix protein content of the formulation. Extruded pellets of this character would generally be maintained in closed containers and would have moisture content ranging from about 5 to about 12%.

The formulations of the present invention may be shaped into any desired object. Further, the formulations may be shaped or molded using injection molding. The melt temperature inside the barrel of the injection molder should be maintained to a level of up to about 90° C., and more preferably up to about 65° C. However, the mold itself would normally be heated to a temperature of from about 120 to about 180° C., in order to denature the grain protein fraction of the formulation introduced into the injection mold. The other parameters of injection molding such as cycle time (ranging from a few seconds to a few minutes) are as employed in the art.

Suitable products to be prepared using the grain protein-based resin formulations of the present invention include, for example, pet chew treats, edible products and biodegradable products in general.

The following examples illustrate the specific formulations and methods of preparing the resin pellets and molded articles.

### EXAMPLES

### Sources and Identity of Materials

Vital Wheat Gluten is a commercially available wheat gluten made by a flash drying process. Wheat gluten can also be made by spray drying so long as the proteins are not denatured and lose visco-elasticity or other viscous properties after hydration.

Midsol™ is a trademark of MGP Ingredients, Inc.

Solka-Floc™ is a trademark of International Fiber Corporation, and is a cellulose fiber.

Panodan™ is a trademark of Danisco, and is a stearate derivative.

Optimizor™ is a trademark of Applied Food Biotechnology, Inc., and is hydrolyzed liver protein derivatives with maltodextrin and complexed with hydrolyzed animal fat/vegetable oil.

### Example 1

Table 1 shows a resin formulation containing 8% hydrolyzed wheat gluten protein (HWG 2009, manufactured by MGP Ingredients, Inc.) in the formulation. The resin pellets were prepared using a 85 mm twin screw extruder (TX-85 manufactured by Wenger) with a hot face die cutter. The powder liquid mix in the extruder is mixed at a melt temperature no more than 95° C. to avoid protein heat denaturing. After the pellet is cut at the die face, the resin pellets are pneumatically transferred to a cooler and packaged.

The presence of 8% hydrolyzed wheat gluten helps increase the shelf life of the resin pellets checked after 4 months. The molded articles exhibited the same characteristics, both appearance and physical properties, as the one molded right after the resin is produced.

TABLE 1
Resin formulation with 8% hydrolyzed wheat gluten

| Ingredient | Weight Percent |
|---|---|
| Midsol ™ HWG 2009 | 8 |
| Hydrolyzed wheat gluten | |
| vital wheat gluten | 66 |
| glycerol monostearate | 2.0 |
| magnesium stearate | 0.9 |
| glycerine | 18.5 |
| water | 2.5 |
| sodium metabisulfite | 0.1 |
| Solka-floc ™ 900 | 2.0 |
| cellulose fiber | |

### Example 2

Table 2 shows a formulation containing 5% hydrolyzed wheat gluten protein-emulsifier complex in the formulation. The hydrolyzed protein-emulsifier complex was prepared by adding Panodan™ SDK emulsifier (provided by Danisco) into the HWG 2009 protein dispersion and spray dried. The hydrolyzed protein-emulsifier complex contains 25% Panodan™ SDK (emulsifier) in the spray dried product.

The resin pellets were prepared using a 85 mm twin screw extruder (TX-85 manufactured by Wenger) with a hot face die cutter. The powder liquid mix in the extruder was mixed at a melt temperature of no more than 95° C. to avoid protein heat denaturation. After cutting at the die face, the resin pellets were pneumatically transferred to a cooler and packaged.

The presence of 5% hydrolyzed wheat gluten-emulsifier complex helped increase the shelf life of the resin pellets checked after 5 months. The molded articles exhibited the same characteristics, both appearance and physical properties, as the one molded right after the resin is produced.

TABLE 2
Resin formulation with 5% hydrolyzed wheat
gluten-emulsifier complex

| Ingredient | Weight Percent |
|---|---|
| Hydrolyzed wheat gluten- | 5 |
| emulsifier complex | |
| Prepared as described | |
| above | |
| vital wheat gluten | 59 |
| glycerol monostearate | 2.0 |
| magnesium stearate | 0.9 |
| glycerine | 18.5 |
| water | 2.5 |
| sodium metabisulfite | 0.1 |
| Solka-floc ™ 900 | 2.0 |
| cellulose fiber | |
| Wheat flour | 10 |

### Example 3

Table 3 shows a formulation containing 3.5% liver digest (Optimizor™ CHX-base, manufactured by Applied Food Biotechnology, Inc) in the formulation. CHX-Base liver digest is a form of hydrolyzed protein, hydrolyzed protein derivative and emulsifier complex where the protein is a poultry liver, and the emulsifier is hydrolyzed animal fats. The hydrolyzed protein derivatives are reaction products of hydrolyzed protein with maltodextrin for aroma enhancement. The resin pellets was prepared using a 85 mm twin screw extruder (TX-85 manufactured by Wenger) with a face die cutter. The powder liquid mix in the extruder is mixed at a melt temperature no more than 95° C. to avoid protein heat denaturing. After die face pellet, the resin pellets are pneumatically transferred to a cooler and packaged.

The presence of 3.5% CHX-Base liver digest assists in increasing the shelf life of the resin pellets checked after 5 months. The molded articles exhibited the same characteristics, both appearance and physical properties, as the one molded right after the resin is produced.

TABLE 3
Resin formulation with 3.5% liver digest

| Ingredient | Weight Percent |
|---|---|
| Optimizor ™ CHX-Base | 3.5 |
| vital wheat gluten | 70.5 |
| glycerol monostearate | 2.0 |
| magnesium stearate | 0.9 |
| Propylene glycol | 18.5 |
| water | 2.5 |
| sodium metabisulfite | 0.1 |
| Solka-floc ™ 900 | 2.0 |
| (cellulose fiber) | |

### Example 4

The resin pellets made according to example 1-3 are injection molded with an injection molding machine. Typical barrel temperature settings of the injection molding machine are: 75° C. (tip end), 70° C., 60° C., 60° C. (feed end). The mold temperature is set at 145° C.

1. A resin formulation useful for forming shaped articles and/or molded snacks, comprising:
a shelf-stabilizing agent including a hydrolyzed protein moiety and selected from the group consisting of hydrolyzed protein, hydrolyzed protein derivatives, and hydrolyzed protein/hydrolyzed protein derivative-emulsifier complexes,
the shelf stabilizing agent being present in an amount ranging from 0.5% to 25% by weight of the resin formulation; and
grain protein ranging from 20% to 80% by weight of the resin formulation.

2. The resin formulation of claim 1 shaped into a one of an edible product and a biodegradable product according to a process that includes at least one step of injection molding the resin formulation or extruding the resin formulation.

3. The resin formulation of claim 1 shaped to form a pet chew treat.

4. The resin formulation of claim 1, wherein the shelf-stabilizing agent comprises the hydrolyzed protein.

5. The resin formulation of claim 4, wherein the hydrolyzed protein is selected from the group consisting of hydrolyzed wheat gluten, hydrolyzed soy protein, hydrolyzed corn gluten, hydrolyzed potato protein, hydrolyzed rice protein, hydrolyzed gelatin protein, hydrolyzed collagen, hydrolyzed casein, hydrolyzed whey protein, hydrolyzed milk protein, hydrolyzed egg white, hydrolyzed egg yoke, hydrolyzed whole egg, hydrolyzed chicken liver, hydrolyzed pork liver, hydrolyzed beef liver, hydrolyzed fish liver, hydrolyzed meat protein of any source, hydrolyzed fish, hydrolyzed blood plasma, and mixtures thereof.

6. The resin formulation of claim 4, wherein the hydrolyzed protein comprises hydrolyzed liver protein.

7. The resin formulation of claim 4, wherein the amount of hydrolyzed protein ranges from 1% to 25% by weight.

8. The resin formulation of claim 4, wherein the amount of hydrolyzed protein ranges from 1.5% to 20% by weight.

9. The resin formulation of claim 4, wherein the amount of hydrolyzed protein ranges from 2% to 15% by weight.

10. The resin formulation of claim 1, wherein the shelf-stabilizing agent comprises the hydrolyzed protein derivative.

11. The resin formulation of claim 10, wherein the hydrolyzed protein derivative comprises a reaction product of a protein hydrolysate with at least one reagent selected from the group consisting of an anhydride, ethylene oxide, propylene oxide, fatty acid, reducing sugars, maltodextrin, oligosaccharide, and dextrin.

12. The resin formulation of claim 11, wherein the hydrolyzed protein derivative contains from 0.5% to 50% hydrolyzed protein by weight of the reaction product.

13. The resin formulation of claim 11, wherein the hydrolyzed protein derivative is a derivative of liver protein hydrolysate.

14. The resin formulation of claim 10, wherein the hydrolyzed protein derivative ranges from 1% to 25% by weight of the resin formulation.

15. The resin formulation of claim 10, wherein the hydrolyzed protein derivative ranges from 1.5% to 20% by weight of the resin formulation.

16. The resin formulation of claim 10, wherein the hydrolyzed protein derivative ranges from 2% to 15% by weight of the resin formulation.

17. The resin formulation of claim 1, wherein the shelf-stabilizing agent comprises the hydrolyzed protein/hydrolyzed protein derivative-emulsifier complex.

18. The resin formulation of claim 17, wherein the hydrolyzed protein/hydrolyzed protein derivative-emulsifier complex comprises hydrolyzed protein/hydrolyzed protein derivatives contacting an emulsifier selected from the group consisting of hydrolyzed vegetable oil, hydrolyzed animal fat, hydrolyzed lecithin and their salt forms, hydrolyzed lecithin modified further by ethylene oxide and propylene oxide, ethoxylated mono- and diglycerides, diacetyl tartaric acid ester of mono-diglycerides, sugar esters of mono- and diglycerides, propylene glycol mono- and diesters of fatty acids, calcium stearoyl-2-lactylate, lactylate sodium stearoyl fumarate, succinylated monoglyceride, sodium stearoyl-2-lactylate, polysorbate 60, or any other emulsifier that contains both hydrophobic and hydrophilic portions in the structure, and mixtures thereof.

19. The resin formulation of claim 18, wherein the emulsifier ranges from 10%-30% by weight of the hydrolyzed protein/hydrolyzed protein derivative-emulsifier complex.

20. The resin formulation of claim 16, wherein the hydrolyzed protein/hydrolyzed protein derivative-emulsifier complex contains a liver protein hydrolysate.

21. The resin formulation of claim 16 wherein the hydrolyzed protein/hydrolyzed protein derivative-emulsifier complex ranges from 1% to 25% by weight of the resin formulation.

22. The resin formulation of claim 16 wherein the hydrolyzed protein/hydrolyzed protein derivative-emulsifier complex ranges from 1.5% to 20% by weight of the resin formulation.

23. The resin formulation of claim 16, wherein the hydrolyzed protein/hydrolyzed protein derivative-emulsifier complex ranges from 2 to 15% by weight of the resin formulation.

24. The resin formulation of claim 4, wherein the hydrolyzed protein moiety has a weight average molecular weight less than or equal to 20 KDa and a number average molecular weight less than or equal to 10 KDa.

25. The resin formulation of claim 10, wherein the hydrolyzed protein moiety has a weight average molecular weight less than or equal to 20 KDa and a number average molecular weight less than or equal to 10 KDa.

26. The resin formulation of claim 17, wherein the hydrolyzed protein moiety has a weight average molecular weight less than or equal to 20 KDa and a number average molecular weight less than or equal to 10 KDa.

27. The resin formulation of claim 1, wherein the grain-based protein is selected from the group consisting of wheat gluten, corn gluten, soy protein, and mixtures thereof.

28. The resin formulation of claim 1, wherein the grain-based protein comprises wheat gluten.

29. The resin formulation of claim 1, wherein the grain-based protein ranges from 20% to 80% by weight of the resin formulation.

30. The resin formulation of claim 1, wherein the grain-based protein ranges from 30% to 75% by weight of the resin formulation.

31. The resin formulation of claim 1, further comprising a plasticizer ranging from 10% to 40% by weight of the resin formulation.

32. The resin formulation of claim 31, wherein the plasticizer is selected from the group consisting of glycerol, diglycerol, propylene glycol, triethylene glycol, urea, sorbitol, mannitol, maltitol, hydrogenated corn syrup, polyvinyl alcohol, polyethylene glycol, and mixtures thereof.

33. The resin formulation of claim 1, further comprising water ranging from 5% to 12% by weight of the resin formulation.

34. The resin formulation of claim 1, further comprising a lubricant ranging from 0.5% to 5% by weight of the resin formulation.

35. The resin formulation of claim 34, wherein the lubricant is selected from the group consisting of glycerol mono/di-stearate, hydrolyzed lecithin, hydrolyzed lecithin derivatives, fatty acid, fatty acid derivatives, and mixtures thereof.

36. The resin formulation of claim 1, further comprising a mold release agent ranging from 0.5% to 3% by weight of the resin composition.

37. The resin formulation of claim 36, wherein the mold release agent is selected from the group consisting of magnesium stearate, calcium stearate, barium stearate, alkaline earth metal fatty acids, and mixtures thereof.

38. The resin formulation of claim 1, further comprising a reducing agent ranging from 0.5% to 5% by weight of the grain protein.

39. The resin formulation of claim 38, wherein the reducing agent is selected from the group consisting of alkali metal sulfites, ammonium sulfites, bisulfites, metabisulfites, nitrites, mercaptoethanol, cysteine, cysteamine, sulfur dioxide, ascorbic acid and mixtures thereof.

40. The resin formulation of claim 38, wherein the reducing agent comprises sodium metabisulfite.

41 The resin formulation of claim 1, further comprising an additional ingredient ranging up to 75% by weight of the resin formulation.

42. The resin formulation of claim 41, wherein the additional ingredient is selected from the group consisting of:
(a) a filler including at least one of a native or chemically modified starch, calcium carbonate, heat denatured protein, vegetable powder, rice flour, wheat flour, corn gluten meal, and fibers;
(b) pigments;
(c) coloring agents;
(d) foaming agents;
(e) other special effect ingredients of predetermined functionality, and
(f) mixtures thereof.

43. The resin formulation of claim 42, wherein the additional ingredient comprises the (a) filler including native or chemically modified starch in granular form, further selected from the group consisting of wheat starch, corn starch, potato, rice, tapioca starches, and mixtures thereof.

44. The resin formulation of claim 42, wherein the additional ingredient comprises the filler including the chemically modified starch as a reaction product of native starch by oxidation, acetylation, carboxymethylation, hydroxyethylation, hydroxypropylation, alkylation, and mixtures thereof.

45. The resin formulation of claim 42, wherein the additional ingredient filler comprises the filler including the, further selected from the group consisting of cellulose fiber, micro-crystalline fiber, soluble fibers, wheat bran, soy bean fiber, corn grit fiber, and mixtures thereof.

46. The resin formulation of claim 42, wherein the additional ingredient comprises the (b) pigments, further selected from the group consisting of titanium dioxide, carbon black, talc, calcium carbonate, and mixtures thereof.

47. The resin formulation of claim 42, wherein the additional ingredient comprises the (c) coloring agents, further selected from the group consisting of azo dyes, chlorophyll, xanthophyll, carotene, indigo, all the synthetic colors, natural coloring agents, and mixtures thereof.

48. The resin formulation of claim 42, wherein the additional ingredient comprises the (d) foaming agents, further selected from the group consisting of sodium bicarbonate, N₂, CO₂, and mixtures thereof.

49. The resin formulation of claim 42, wherein the additional ingredient comprises the (e) other special effect ingredients, further selected from the group consisting of breath enhancers and dental cleaning ingredients.

50. The resin formulation of claim 41, wherein the additional ingredient comprises a granular starch.

51. The resin formulation of claim 50, wherein the granular starch is selected from the group consisting of corn starch, wheat starch, potato starch, rice starch, tapioca starch, and mixtures thereof.

52. The resin formulation of claim 50, wherein the granular starch comprises a chemically modified starch.

53. The resin formulation of claim 50, wherein the granular starch ranges from 0.001% to 70% by weight of the resin formulation.

54. A chew treat product comprising:
a shelf-stabilizing agent including a hydrolyzed protein moiety and selected from the group consisting of hydrolyzed protein, hydrolyzed protein derivatives, and hydrolyzed protein/hydrolyzed protein derivative-emulsifier complexes,
the shelf stabilizing agent being present in an amount ranging from 0.5% to ²⁵% by weight of the resin formulation; and
grain protein ranging from 20% to 80% by weight of the resin formulation,
the shelf-stabilizing agent and the grain protein forming a mixture that is shaped as a pet chew treat.

55. A method of forming grain protein-based containing pellets, which can be used in injection molding equipment for the production of articles, the method comprising the steps of:
(a) providing a formulation comprising from 20% to 80% by weight grain protein, from 10 to 40% plasticizer, and from 1% to 25% of a shelf stabilizing agent selected from the group consisting of hydrolyzed proteins, hydrolyzed protein derivatives, hydrolyzed protein/hydrolyzed protein derivative-emulsifier complexes, and mixtures thereof;
(b) heating the formulation; and
(c) forming pellets by extrusion, the heating step being carried out so that the formulation is heated to a sufficient temperature in the extruder to render the formulation substantially homogeneous and flowable with the avoidance of any substantial heat denaturation of the grain-based protein formulation.

56. The method of claim 55, wherein heating step is performed at a maximum temperature less than or equal to 95° C.

57. The method of claim 55, wherein the formulation contains from 20% to 80% by weight grain protein.

58. The method of claim 55, wherein the formulation contains from 0.001% to 75% by weight of granular starch.

59. The method of claim 55, wherein the formulation contains from 0.5% to 5% of a reducing agent by weight of the grain protein.

60. The method of claim 55, wherein the grain protein is selected from the group consisting of soy protein, wheat gluten, corn gluten, and mixtures thereof.

61. The method of claim 55, wherein the grain protein comprises wheat gluten.

62. The method of claim 58, the starch being selected from the group consisting of corn starch, wheat starch, potato starch, tapioca starch and mixtures thereof.

63. The method of claim 55, the plasticizer being selected from the group consisting of glycerol, diglycerol, propylene glycol, triethylene glycol, urea, sorbitol, mannitol, maltitol, hydrogenated corn syrup, polyvinyl alcohol, polyethylene glycol, C₁₂-C₂₂ fatty acids and metal salts of such fatty acids, and mixtures thereof.

64. The method of claim 55, wherein the plasticizer comprises glycerol.

65. The method of claim 55, wherein the formulation comprises a reducing agent selected from the group consisting of the alkali metal and ammonium sulfites, bisulfites, metabisulfites and nitrites, and mercaptoethanol, cysteine, cysteamine, sulfur dioxide, ascorbic acid and mixtures thereof.

66. The method of claim 55, wherein the formulation comprises a filler selected from the group consisting of titanium dioxide, carbon black, talc and carbonate salts.

67. The method of claim 55, wherein the formulation contains a quantity of fiber therein.

68. The method of claim 55, wherein the formulation contains a quantity of a lubricant/mold release agent selected from the group consisting of vegetable and animal oils and fats, the alkali metal and alkaline earth stearates and mixtures thereof.

69. The method of claim 68, where the lubricant mold release agent is present at a level ranging from 0.5% to 3.0% by weight of the formulation

70. The method of claim 55, the formulation including a colorant.

71. The method of claim 55, further comprising the steps of:
passing the pellets through injection molding equipment having a barrel and a mold capable of forming an article,
the passing step comprising the steps of rendering the pellets flowable in the barrel while maintaining the temperature of the flowable pellet material up to a maximum temperature less than 95° C., and
heating the mold to a temperature of from 12⁰° C. to 180° C.

72. The method of claim 71, further comprising a step of transferring the flowable pellet material into the mold to form the article.

73. The method of claim 72, wherein the article produced in the transferring step is a pet chew treat.
